(19) United States
(12) Patent Application Publication
(10) Pub. No.: US 2005/0282106 A1
(43) Pub. Date: Dec. 22, 2005

(54) Hole guide for mini and standard dental implants

(76) Inventors: Harold I. Sussman, Scarsdale, NY (US); Stephen J. Hadwin, Ardmore, OK (US)

Correspondence Address: NOTARO AND MICHALOS, 100 DUTCH HILL ROAD, SUITE 110, ORANGEBURG, NY, 10962-2100, US

(21) Appl. No.: 10/869,298

(22) Filed: Jun. 16, 2004

(51) Int. Cl. A61C 3/02

(52) U.S. Cl. 433/76

(57) ABSTRACT

An implant hole guide is used for drilling a hole in jaw bone for a dental implant. A guide member of the guide has opposite ends and opposite surfaces, one being adapted to engage a jaw bone adjacent the site of a hole to be drilled. A guide bore extends in the guide member adjacent one end for guiding the drill. A second bore is spaced from the first bore in the guide member and either engages a previous implant to properly locate the first bore over a further hole site on the jaw, or for guiding the drilling of another implant hole in the jaw. The bores are parallel to each other and are spaced by a minimum center-to-center implant distance sufficient to maintain at least 3 mm of jaw bone between adjacent implant receiving holes in the jaw bone.

### FIELD AND BACKGROUND OF THE INVENTION

The present invention relates generally to dental implants, and in particular to a new and useful dental implant guide which provides a dentist with an intuitive and effective device for properly positioning and drilling the holes needed for various types of dental implants.

Since 1981, dental root form implants have become a standard procedure for replacing missing teeth. Unlike other dental procedures such as crown and bridge work, root canals and the like, which utilize at least part of the original tooth as a foundation for the tooth replacement, implants require the drilling of holes directly into the bone of the jaw.

Although dental implants have many benefits, particularly where a patient is missing teeth over large portions of the mouth, various complications can follow implant placement, especially to adjacent teeth. The bone may be overheated during implant surgery, for example, and this can devitalize an adjacent tooth. Endodontic lesions can also form which compromise the implant fixture by preventing integration of the bone around the fixture (osseointegration), causing loss of the implant.

Another problem involves a patient with no teeth or so called edentulous patients.

A further problem facing the implantologist is the importance of avoiding any invasion of the jaw in the area of the mental foramens or MF, which exist on opposite sides of the lower jaw. No implant hole should be made any closer than 6 mm from either MF or there will be the risk of penetrating an anterior loop of the inferior alveolar nerve which may be present in this area.

Within the confines of the mouth, it is also very difficult to accurately align a dental bur for drilling the crucial initial pilot hole of about 2 mm in diameter needed for a standard implant of about 3 to 4 mm in diameter. The pilot hole must be drilled along an acceptable axis into the jaw bone which both avoids any critical structures in the bone such as nerves, blood vessels and the like, but also avoids intersecting the root of an adjacent tooth which may not be apparent without an x-ray. Even with x-rays, however, it is difficult for a dentist to accurately align the bur without some help.

When installing so-called “mini-implants” of only about 1.5 to 2.5 mm diameter, the final hole can be drilled in one step with only an initial pilot starter hole needed, and this hole is drilled through the gum tissue and into the bone, rather than exposing the jaw bone before drilling takes place as with standard implants. Such mini-implants also have the advantage of being implantable during a single patient visit, unlike standard implants that require a lengthy healing period for allowing the bone of the jaw to incorporate the implant before any dental prostheses can be connected.

Mini-implants are available from IMTEC Corporation of Ardmore, Okla., and are known as the IMTEC Sendax System. U.S. Pat. Nos. 5,749,732 to Sendax et al. and 6,716,030 to Bulard et al., further disclose this technology.

U.S. Pat. No. 5,888,065, invented by the present inventor, discloses a dental implant guide arrangement that is capable of accurately guiding a bur for drilling a pilot hole for a standard dental implant. The arrangement includes a pair of jaws which engage lingual and buccal surfaces of a tooth and are held to each other by a fixing mechanism, such as a screw. A guide member extends from one of the jaws and has a semi-cylindrical guide that is parallel to an acceptable axis for the pilot hole. The bur can be guided along the guide for accurately drilling the pilot hole. Also see the inventor's U.S. Pat. Nos. 6,062,856 and 6,626,667.

A complex and time consuming technique for properly aligning the initial implant hole is disclosed in U.S. Pat. No. 5,015,183. According to this method, a stent comprising a negative impression of a patient's teeth in the vicinity of the implant is taken. Multiple x-ray opaque strips are placed in the negative impression and an oblique x-ray is taken. This x-ray is used as a diagnostic tool for the patient's jaw structure to help plot the trajectory of an implant fixture in the jaw. Another problem associated with the use of a stent is that when a surgical stent is fabricated from an alginate jaw impression, as is commonly done, the registration of the surface jaw tissue does not always reflect the underlying topography of the jaw bone where the implant is to be placed.

In any case, once an acceptable initial implant hole is formed in the jaw, subsequent holes can be produced by using the initial hole as a guide. This is when multiple implants are to be installed. See, for example, U.S. Pat. Nos. 5,741,133 and 5,302,122. Other techniques and apparatuses for drilling holes in the jaw bone are disclosed in U.S. Pat. Nos. 4,787,848 and 4,998,881.

U.S. Pat. No. 5,842,859 discloses a simple implant hole drilling guide but with only an open guide surface but no encircling guide bore for the drill. U.S. Pat. No. 5,833,693 uses a circular but not cylindrical drill guide bore and a length adjustable block with a downwardly extending hole engaging pin and an upwardly extending handle. Also see U.S. Pat. No. 4,325,373 for a guide with a hole engaging pin.

### SUMMARY OF THE INVENTION

The present invention is used to properly locate and drill the critical first holes for standard and/or mini-implants, and any number of subsequent holes which are all properly located, spaced and oriented. This can be done for the upper and/or the lower jaw of a patient, and whether the patient has no teeth (edentulous) or some teeth.

Accordingly, an object of the present invention is to provide an implant hole guide for use in drilling a hole in a jaw bone in preparation for receiving a dental implant, the jaw bone having a ridge for receiving an entry opening of the hole to be drilled.

Another object of the invention is to provide such a guide which comprises a guide member having an inner surface, preferably with an elongated recess for receiving the ridge of the jaw bone when the guide member is engaged over the jaw bone, and an opposite outer surface, a first end and an opposite second end, a buccal surface and an opposite lingual surface. A first, preferably but not necessarily, cylindrical drill guide bore extends through the guide member from the outer surface to the inner surface and adjacent the first end of the guide member for guiding a drill for drilling a hole into the jaw bone. A second bore which is parallel to the first bore, extends in the guide member adjacent the second end of the guide member. The second bore preferably has a larger inside diameter then the first bore and the first and second bores are spaced from each other by a minimum distance which is sufficient to maintain at least 3 mm of jaw bone between adjacent implant receiving holes in the jaw bone when the second bore is used to engage an implant in one of the holes, or is used to guide the drilling of one of the holes.

A still further object of the invention is to provide a method of placing a plurality of dental implant receiving holes in a jaw bone, the jaw bone having a ridge for receiving an entry opening of the hole to be drilled by using the implant hole guide of the invention for drilling the holes in a jaw bone in preparation for receiving the dental implants.

The method includes locating, e.g., by marking the center of the jaw bone, and whether drilling directly into the exposed bone or through the gum covering the bone, using the center mark and the guide of the invention to drill the first hole through the first drill guide bore. A mini-implant is then installed in the newly created hole. The second bore of the guide is then engaged on the mini-implant with the first drill guide bore now extending to the opposite side of the jaw bone and over the mark. A second hole is then drilled using the first drill guide bore, which is properly spaced on the opposite side of the mark and with proper spacing between the holes.

The same or a different guide of the invention is then used to locate and drill the next lateral hole in the jaw. Four holes can be created in this way without coming close to the MF or mental foramens of the lower jaw in particular, and thus avoiding the serious danger of damaging structures in this sensitive area.

Various handle structures and safety features such as a floss loop, can be used in the guide and method of the invention and the size and placement of the bores will vary depending on whether the guide is used for standard or mini-implants.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which a preferred embodiment of the invention is illustrated.

### BRIEF DESCRIPTION OF THE DRAWINGS

In the drawings:

FIG. 1 is a top plan view of an implant hole guide illustrating a first embodiment of my invention for mini-implants;

FIG. 2 is a side sectional view of the embodiment of FIG. 1, taken along line 2-2 of FIG. 1;

FIG. 3 is a front sectional view of the embodiment of FIG. 1, taken along line 3-3 of FIG. 1;

FIG. 4 is a top plan view of an implant hole guide illustrating a second embodiment of my invention for drilling holes for additional mini-implants or for drilling holes for standard implants;

FIG. 5 is a side sectional view of the embodiment of FIG. 4, taken along line 5-5 of FIG. 1;

FIG. 6 is a front sectional view of the embodiment of FIG. 4, taken along line 6-6 of FIG. 1;

FIG. 7 is a schematic front view of the implant hole guide of the present invention over a lower jaw bone after it has been prepared according to the method of the present invention for drilling an initial pilot hole for a standard implant or for drilling a final hole for a mini-implant in the bone;

FIG. 8 is a view similar to FIG. 7, showing the implant hole guide of the present invention over the jaw bone during a further step in the method of the present invention;

FIG. 9 is a view similar to FIG. 7, showing the implant hole guide of the present invention over the jaw bone during a still further step in the method of the present invention;

FIG. 10 is a view similar to FIG. 7, showing the results of using the present invention after a final step in the method of the present invention;

FIG. 11 is a top perspective view of another embodiment of the implant hole guide of the present invention;

FIG. 12 is a top perspective view of a still further embodiment of the implant hole guide of the present invention;

FIG. 13 is a top plan view of still a further embodiment of the implant hole guide of the present invention; and

FIG. 14 is a side sectional view of still a further embodiment of the implant hole guide of the present invention.

### DESCRIPTION OF THE PREFERRED EMBODIMENTS

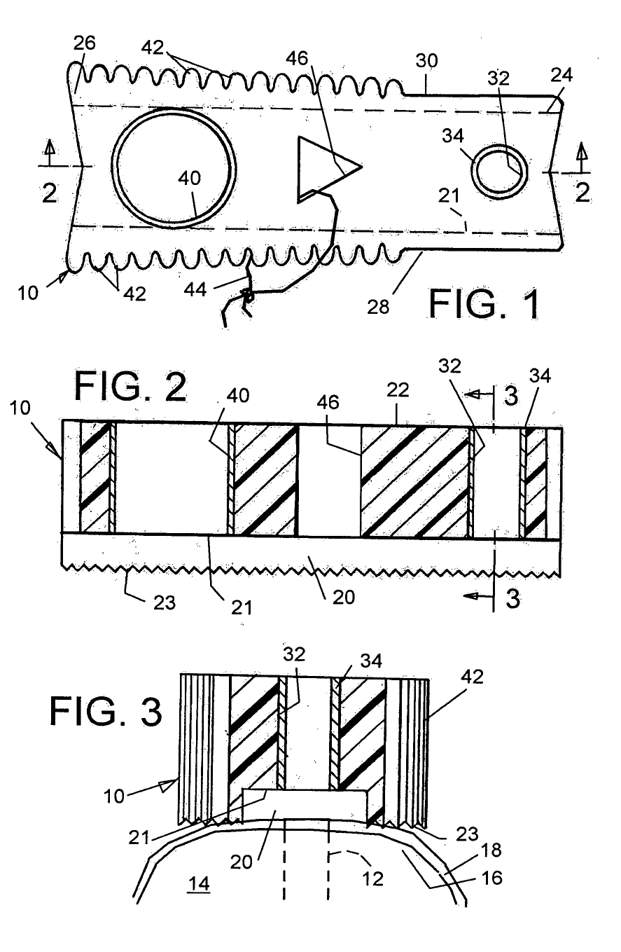

Referring now to the drawings in which like reference numerals are used to refer to the same or functionally similar elements, FIGS. 1, 2 and 3 illustrate an implant hole guide 10 for use in drilling a hole 12 in a jaw bone 14 in preparation for receiving a dental implant. The jaw bone has a ridge 16 for receiving an entry opening of the hole 12 to be drilled, and may be covered by gum tissue 18 for certain procedures for installing mini-implants, or may have the gum tissue temporarily moved aside for installing standard implants as will be explained later.

The guide member 10 has an inner surface 20 for engaging the ridge of the jaw bone when the guide member is engaged onto the jaw bone, and an opposite outer surface 22. The guide 10 also has a first end 24 and an opposite second end 26. The guide has a buccal surface 28 and an opposite lingual surface 30, however, these surfaces are interchangeable depending on the orientation of the guide when in use.

Guide 10 is preferably made of plastic and even more preferably of transparent plastic such as acrylic. A first preferably cylindrical drill guide bore 32, which is preferably lined with a thin metal, e.g., titanium liner 34, extends through the guide member 10 from the outer surface 22 to the inner surface 20 and adjacent the first end 24 of the guide member. Bore 32, which can alternatively be polygonal, oval or have some other shape, is used for guiding a drill for drilling a hole into the jaw bone. It is advantageously about 1.3 mm in diameter for guiding a bur or dental drill of 1.1 mm diameter, for making the hole of a mini-implant, e.g., of the type sold by IMTEC.

Larger or smaller diameters are also appropriate for first bore 32, e.g. from about 1 to about 4 mm, for closely guiding other burs for the holes of other implants.

A second bore 40, which is preferably but not necessarily cylindrical and metal lined, is provided in guide member 10, parallel to the first bore 32, and extending at least partly through in the guide member, but preferably entirely through the guide member from the outer surface to the inner surface. Bore 40 is adjacent the second end 26 of the guide member. The first and second bores 32, 40 are spaced from each other by a minimum distance which is sufficient to maintain at least 3 mm of jaw bone between adjacent implant receiving holes in the jaw bone when the second bore is used to engage an implant in one of the holes, or is used to guide the drilling of one of the holes.

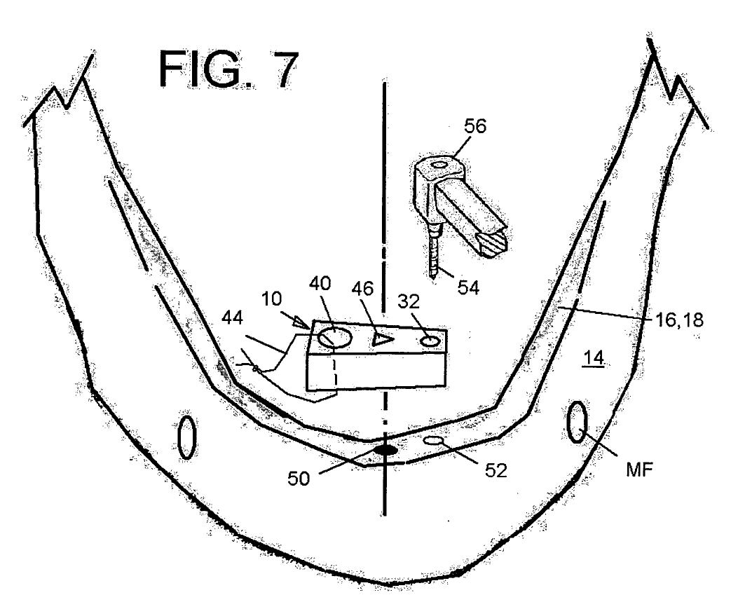

In the embodiment of FIGS. 1-3, the bores are 10 mm (1 cm) apart, center-to-center for a guide member for use in installing the IMTEC mini-implants as will be explained in greater detail later and with reference to FIGS. 7 to 10. Other spacing is also possible depending on the type of implant and implant distribution required. In general, the center-to-center spacing of the bore should be between about 6 to 10 mm.

Bore 40 in the embodiment of FIGS. 1-3 is about 3.2 mm in diameter for use to closely engage the outer projection of the IMTEC or other mini-implant, above the gum line, to accurately align the first bore 32 of the guide member over a further implant hole site in the bone ridge 16, when the guide is engaged onto the ridge. This sets the proper spacing between implant holes and makes sure that there is enough room for the crown, bridge or other replacement structure to be secured on the implants. Parallel implant holes are also assured by the invention.

In order to better align the guide member 10 on the bone 14, whether covered by gum or not, the inner surface 20 of the guide member has an elongated recess 21 for receiving the convex ridge of the jaw bone when the guide member is engaged onto the jaw bone as shown in FIG. 3.

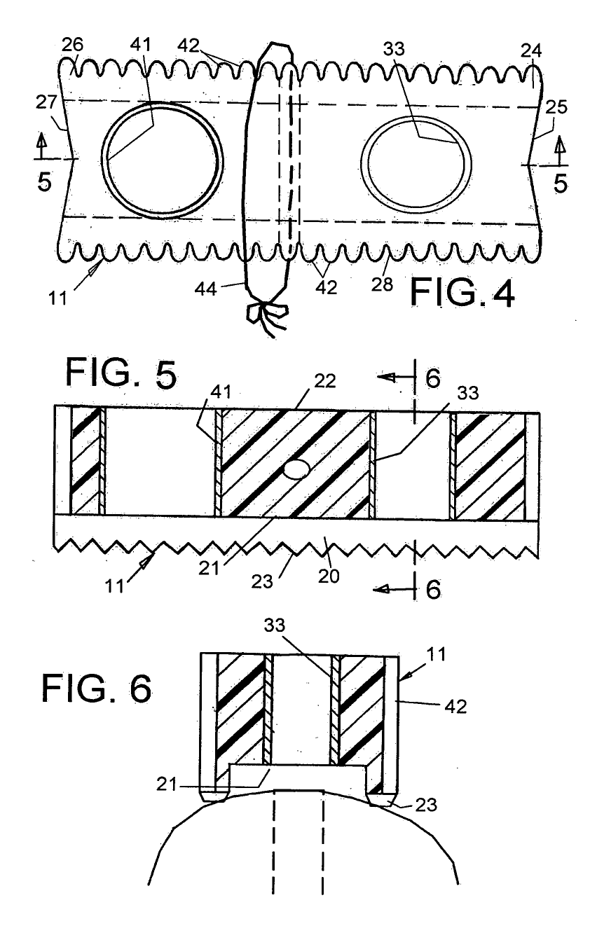

The inner surface 20, at least on opposite sides of the recess 21, has anti-slip means such as sawtooth serrations, teeth in a diamond pattern, roughness or other texture 23, which is adapted to prevent slipping of the guide member on the jaw bone by either engaging gum tissue 18 over the jaw bone ridge 16, if the guide member is to be used for drilling a hole into the jaw bone through the gum tissue, or by directly engaging the ridge 16 after the gum tissue has been moved aside if the guide member is to be used for drilling a hole directly into exposed jaw bone as with some uses for the embodiment of FIGS. 4-6. In the embodiment of FIGS. 4-6, the teeth 23 for bone engagement are deeper than the teeth 23 in the embodiment of FIGS. 1-3 for engaging the gum.

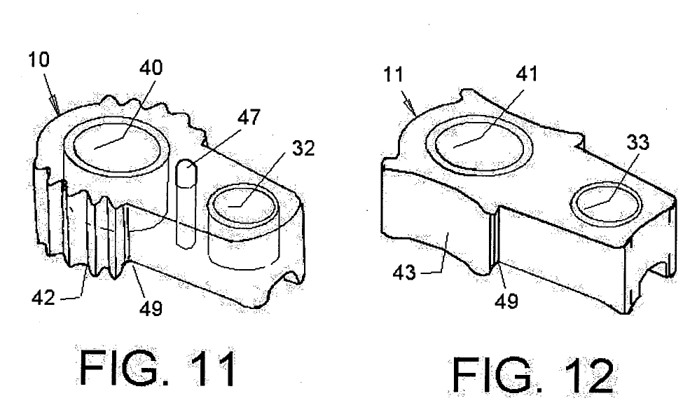

Handle or grip means 42 are also provided on the buccal and lingual surfaces 28, 30 of the guide member 10, at least at the second end 26 of the guide member adjacent the second bore 40, for facilitating holding of the guide member by a dental implant practitioner. Means 42 can be periodic ridges and valleys as shown, or knurling or texture, or a special shape, for example shown in FIGS. 11 and 12, or other means for allowing the implantologist to better hold onto the guide.

FIG. 1 also shows one possible placement for a loop of safety string or floss 44 engaged to the guide to help the practitioner retrieve the guide from the patient's mouth. Safety floss may alternatively extend in bore 40.

In the embodiment of FIG. 4, a separate transverse bore is provided for safety floss 44, but in the embodiment of FIG. 1, floss 44 is shown extending through a triangular sighting bore 46 which is only one of a wide variety of sighting means of the present invention, placed between the first and second bores 32, 40, for sighting a center location or mark on the jaw bone to locate the guide for drilling a hole using the first bore 32, as will be explained later. Center-to-center distance from sighting bore 46 to each of bores 32 and 40 is 5 mm each.

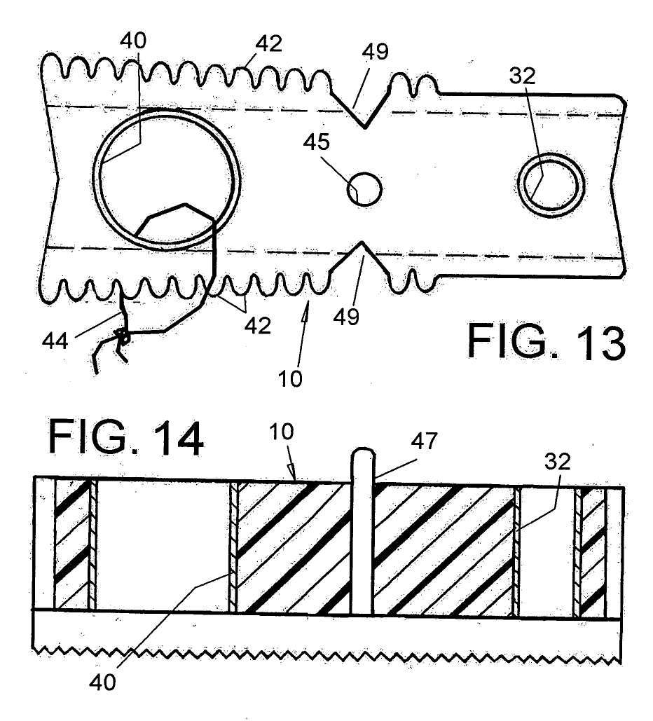

In FIG. 13, the sighting means is a small diameter aperture 45 through the guide member that is equally spaced from the first and second bores 32, 40, and only about 0.5 mm in diameter. In the embodiment of FIG. 14, the sighting means is a small diameter metal pin 47 extending in the guide member 10 and projects up about 3 mm from the outer surface of the guide member. In both these embodiments, the guide member is made of transparent material so that the sighting means and the underlying jaw, as well as the selected jaw bone location or mark, are in plain sight. An additional or alternative sighting means in FIG. 13 is one or a pair of side notches 49 placed between the bores 32 and 40.

In the embodiments of FIGS. 11 and 12, the sighting means can simply be the notches 49 forming the ends of the grips or handles 42, 43 respectively.

The embodiment of FIGS. 4-6 illustrates a guide construction which can either be used for drilling the pilot and the final hole for standard implants or for drilling further mini-implant holes in the jaw bone.

The guide member 11 in FIG. 4 has a vertical, preferably V-shaped and concave tooth engaging surface 25 at the first end 24 of the guide member which is adapted to engage the side of a tooth in the jaw bone adjacent a site into which an implant hole is to be guided using a first cylindrical bore 33. The tooth engaging surface 25 is positioned so that when engaged against a tooth a minimum selected distance, e.g. 5 mm, is established between the tooth and the first drill guide bore 33, and the corresponding hole to be made using the bore. A similar tooth engaging surface 27 is at the opposite end 26 of guide member 11, and likewise maintains a minimum, e.g., 5 mm spacing to the hole to be made using the bore 41 at that end of the guide.

Bore 33 is advantageously about 2.3 mm in diameter for guiding the drilling of a standard implant pilot hole of 2 mm diameter using a 2 mm bur, and bore 41 is about 3.5 mm for guiding the drilling of the final implant hole of 3.2 mm diameter using a 3.2 mm bur.

The center-to-center spacing of bores 33, 41 is 7 mm for proper spacing between implants.

When used as the second guide for the holes of further mini-implants, bores 33, 41 have the same respective diameters as bores 32, 40 of FIG. 1 (i.e. 1.3 and 3.2 mm, respectively).

Other representative dimensions for the guide are a buccal to lingual surface width at the first end 24 of about 4 mm and at the second end 26 of about 6 mm between the valleys of gripping means 42 and about 8 mm between the peaks.

FIGS. 7 to 10 illustrate the method for placing a plurality of dental implant receiving holes in a jaw bone, according to the present invention,

The jaw bone 14 with ridge 16 for receiving entry openings of the implant holes can be drilled either directly or with gum tissue 18 covering the jaw bone when mini-implants are to be installed. The first step is locating a center point 50 on the jaw bone or gum over the jaw bone. Advantageously, but not essentially, this location is marked by an ink spot or other nontoxic marking agent. The philtrum of the lip or center of the nose can be used as a landmark to find point 50, and the operation can be used for the upper or the lower jaw.

The guide member 10 is then placed on the jaw bone ridge with the sight means 46 exactly over center point 50. When the sight bore 46 is triangular, the point of the triangle can be used as an indicator of the correct orientation of the guide member, and actually point to the bore 32 to be use in making the first hole.

The first bore 32 is placed over a first site 52 for a first implant hole to be drilled and drilling the first implant hole using the first bore to guide a drill or bur 54 in a handpiece 56 is performed. In FIG. 7, the guide member is shown above the bone ridge. In use, the guide member with its recess 21 will rest on the bone or gum-covered bone, before the hole is drilled. During this operation, the guide member is held firmly between the thumb and forefinger of the practitioner's hand. The safety floss 44 is shown in second bore 40 in FIG. 7 so as not to encumber the sighting bore 46 or the drill guiding bore 32.

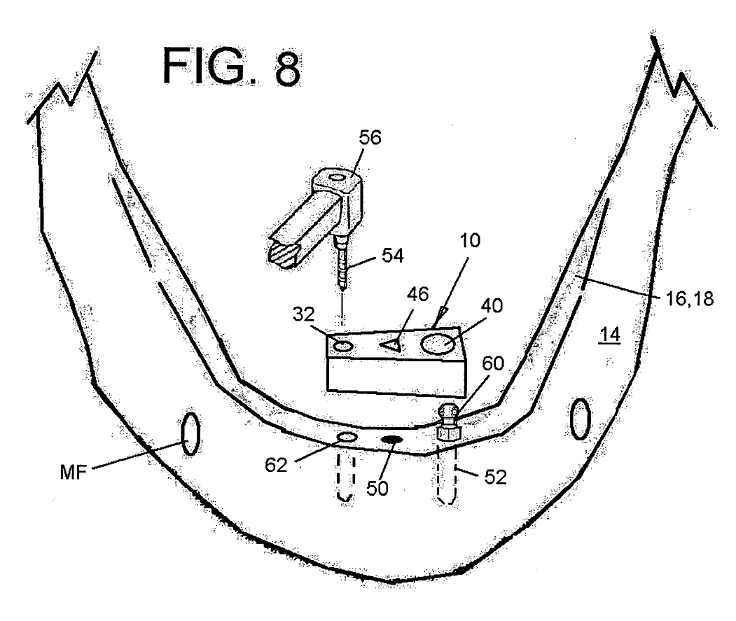

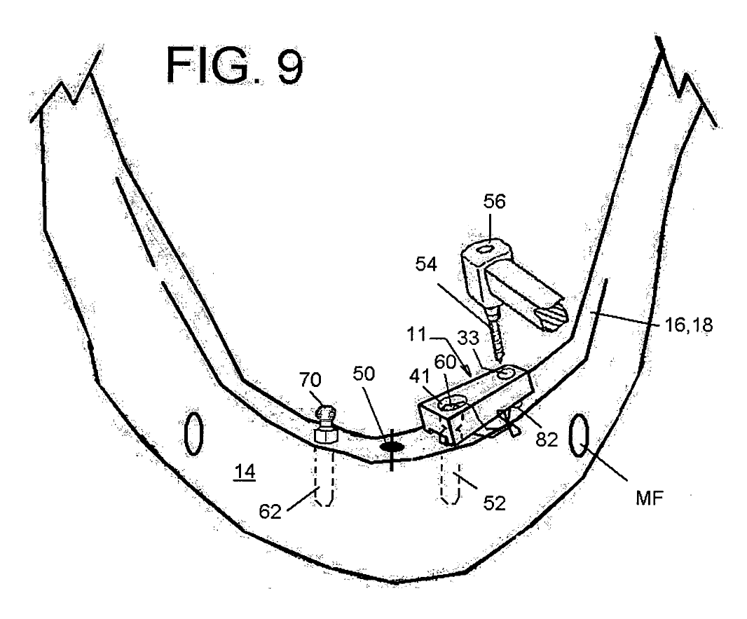

FIG. 8 shows further steps of the method including inserting a mini-implant 60 into the first implant hole 52 with a portion of the mini-implant extending above the ridge and gum 16, 18. The guide member is then turned 180 degrees and in the horizontal plane and the second bore 40 is engaged onto the mini-implant projection with the guide member engaged on the ridge and with the first bore 32 now over a further site 62 for a further implant hole to be drilled which is exactly 10 mm from the first hole 52 due to the spacing between bores 32 and 40, and on the opposite side of mark 50. Drilling the further implant hole 62 then takes place using the first bore to guide the drilling operation.

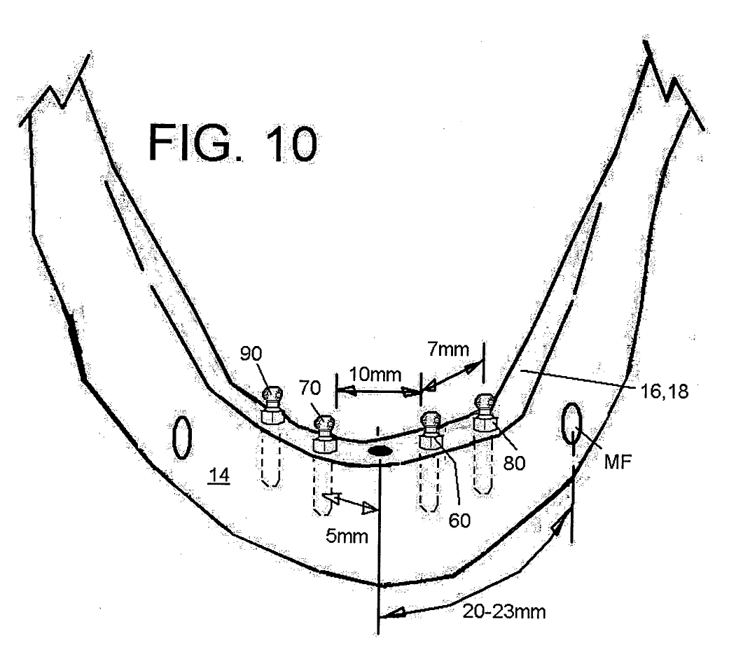

As shown in FIG. 9, the method of the invention further includes inserting another mini-implant 70 into the second hole 62, providing a second guide 11 of the type shown in FIGS. 4-6 having first and second spaced apart parallel bores 33 and 41, engaging the second bore 41 of the second guide 11 onto the projection of the first implant 60 and, with first bore 33 over a still further hole site 82, drilling a further hole. The same is done for the jaw bone on the opposite side of center mark 50 and implants 80 and 90 are installed to create the result shown in FIG. 10.

To help the practitioner better differentiate between the two guides, that is the 10 mm spacing guide 10 and the 7 mm spacing guide 11, and to help quickly identify the first bore 32 or 33, the embodiment of FIG. 11 shows guide member 10 to have serrated grip 42 at one end only, even though the grip surface can extend the full length of the member as in the embodiment of FIG. 4. The sight means, e.g. pin 47, is also provided in the 10 mm guide member 10 of FIG. 11 to quickly identify it as the 10 mm guide. The guide members 10 and 11 of both FIGS. 11 and 12 are also wedge shaped with the narrow end at the small diameter bore 32 and 33, respectively. The 7 mm guide of FIG. 12 may also have non-serrated, “elephant ears” grips or handles 43 and no pin if it is to be the 7 mm guide.

In FIG. 10, four mini-implants 60, 70, 80 and 90 are accurately placed in the jaw bone, centered properly in the mouth and all well spaced from the mental foramens or MF on both sides of the jaw. The MF is known to lie about 20 to 23 mm for the center location 50 while the center implants 60 and 70 will be exactly 10 mm apart and each lateral implant 80 and 90 will be 7 mm from its neighbor for a total of only 12 mm for the two implants on each side of mark 50. This provides a safety margin of 8 to 11 mm from each MF.

For standard implants or as an alternative for mini-implants, one of the bores 32 or 40 in implant guide member 10, or one of the bore 33 or 41 in guide member 11 can be used to sight the mark 50 while the other is used to guide drilling of the hole. The hole can be used to sight for the next implant and so on for proper placement, positioning and spacing of all the implants in a very simple and intuitive manner.

While specific embodiments of the invention have been shown and described in detail to illustrate the application of the principles of the invention, it will be understood that the invention may be embodied otherwise without departing from such principles.

1. An implant hole guide for use in drilling a hole in a jaw bone in preparation for receiving a dental implant, the jaw bone having a ridge for receiving an entry opening of the hole to be drilled, the guide comprising:
a guide member having an inner surface for engaging the ridge of the jaw bone when the guide member is engaged onto the jaw bone, and an opposite outer surface, a first end and an opposite second end, a buccal surface and an opposite lingual surface;
a first drill guide bore extending through the guide member from the outer surface to the inner surface and adjacent the first end of the guide member for guiding a drill for drilling a hole into the jaw bone;
a second bore which is parallel to the first bore, extending in the guide member adjacent the second end of the guide member; and
the first and second bores being spaced from each other by a minimum distance which is sufficient to maintain at least 3 mm of jaw bone between adjacent implant receiving holes in the jaw bone when the second bore is used to engage an implant in one of the holes or is used to guide the drilling of one of the holes.

2. A guide according to claim 1, wherein the inner surface of the guide member has an elongated recess for receiving the ridge of the jaw bone when the guide member is engaged onto the jaw bone.

3. A guide according to claim 1, including grip means on the buccal and lingual surfaces of the guide member, at least at the second end of the guide member adjacent the second bore, for facilitating holding of the guide member by a dental implant practitioner.

4. A guide according to claim 1, including anti-slip means on the inner surface of the guide member on opposite sides of the recess, which is adapted to prevent slipping of the guide member on the jaw bone by either engaging gum tissue over the jaw bone ridge if the guide member is to be used for drilling a hole into the jaw bone through the gum tissue, or by directly engaging the ridge after the gum tissue has been moved aside if the guide member is to be used for drilling a hole directly into exposed jaw bone.

5. A guide according to claim 1, including a safety string engaged to the guide.

6. A guide according to claim 1, including an aperture through the guide member that is spaced from the first and second bores for receiving a safety string.

7. A guide according to claim 1, including a safety string received in the second bore, the second bore being adapted to engage an implant in the jaw bone for helping to position the first bore over a selected implant hole site on the jaw bone ridge.

8. A guide according to claim 1, including a cylindrical metal lining in at least the first bore.

9. A guide according to claim 1, wherein the guide member is made of plastic and including a metal lining in at least the first bore.

10. A guide according to claim 1, wherein the guide member is made of plastic and including a cylindrical metal lining in each of the first and second bores.

11. A guide according to claim 1, wherein the guide member is made of plastic and including a cylindrical titanium lining in at least one of the first and second bores.

12. A guide according to claim 1, wherein the first end of the guide member has a tooth engaging surface which is adapted to engage a tooth in the jaw bone adjacent a site into which an implant hole is to be guided using the first bore, the tooth engaging surface being positioned so that when engaged against a tooth a minimum selected distance is established between the tooth and the first drill guide bore.

13. A guide according to claim 1, wherein the guide member is made of transparent plastic and including a metal lining in at least one of the first and second bores.

14. A guide according to claim 1, including sight means between the first and second bores for sighting a center location of the jaw bone to locate the guide for drilling a hole using the first bore.

15. A guide according to claim 14, wherein the sight means comprises a further bore in the guide between the first and second bores.

16. A guide according to claim 14, wherein the sight means comprises a pin in the guide between the first and second bores.

17. A guide according to claim 14, wherein the sight means comprises a notch in at least one of the buccal and lingual surfaces of the guide, between the first and second bores.

18. A method for placing a plurality of dental implant receiving holes in a jaw bone, the jaw bone having a ridge for receiving an entry opening of each hole to be drilled either directly or with gum covering the jaw bone, the guide including a guide member having an inner surface for engaging the ridge of the jaw bone when the guide member is engaged onto the jaw bone and an opposite outer surface, a first end and an opposite second end, a buccal surface and an opposite lingual surface, a first drill guide bore extending through the guide member from the outer surface to the inner surface and adjacent the first end of the guide member for guiding a drill for drilling a hole into the jaw bone, a second bore which is parallel to the first bore, extending in the guide member adjacent the second end of the guide member, and sight means between the first and second bores, the method comprising:
locating a center point on the jaw bone;
placing the guide member onto the jaw bone with the sight means adjacent the center point and the first bore over a first site for a first implant hole to be drilled; and
drilling the first implant hole using the first bore to guide the drilling.

19. The method according to claim 18, including inserting a mini-implant into the first implant hole with a portion of the mini-implant extending above the ridge, engaging the second bore onto the mini-implant with the guide member engaged on the ridge and with the first bore over a further site for a further implant hole to be drilled, and drilling the further implant hole using the first bore to guide the drilling.

20. The method according to claim 18, including inserting a mini-implant into the first hole, providing a second guide having first and second spaced apart parallel bores, aligning the second bore of the second guide with the first hole by engaging the second bore of the second guide into the portion of the mini-implant extending above the ridge and with the first bore of the second guide over a further site for a further implant hole to be drilled, and drilling the further implant hole using the first bore of the second guide to guide the drilling.

21. A method for placing a plurality of dental implant receiving holes in a jaw bone, the jaw bone having a ridge for receiving an entry opening of each hole to be drilled either directly or with gum covering the jaw bone, the guide including a guide member having an inner surface for engaging the ridge of the jaw bone when the guide member is engaged onto the jaw bone and an opposite outer surface, a first end and an opposite second end, a buccal surface and an opposite lingual surface, a first drill guide bore extending through the guide member from the outer surface to the inner surface and adjacent the first end of the guide member for guiding a drill for drilling a hole into the jaw bone, and a second bore which is parallel to the first bore, extending in the guide member adjacent the second end of the guide member, the method comprising:
placing the guide member onto the jaw bone with the second bore over a selected location on the jaw bone and the first bore over a site for drilling of an implant hole in the jaw bone; and
drilling an implant hole at the site using the first bore to guide the drilling.

22. The method according to claim 21, wherein the selected location comprises a mini-implant in a previously formed implant hole with a portion of the mini-implant extending above the ridge, the method including engaging the second bore onto the mini-implant with the guide member engaged on the ridge and with the first bore over the site the implant hole to be drilled.
